(19) United States
(12) Patent Application Publication
(10) Pub. No.: US 2004/0127256 A1
(43) Pub. Date: Jul. 1, 2004

(54) Mobile device equipped with a contactless smart card reader/writer

(76) Inventors: Scott Goldthwaite, Hingham, MA (US); William Graylin, Woburn, MA (US)

Correspondence Address: AKC PATENTS, 215 GROVE ST., NEWTON, MA, 02466, US

(21) Appl. No.: 10/625,823

(22) Filed: Jul. 23, 2003

Related U.S. Application Data
(60) Provisional application No. 60/399,686, filed on Jul. 30, 2002.

(51) Int. Cl. H04M 1/00

(52) U.S. Cl. 455/558; 455/466

(57) ABSTRACT

A wireless mobile device is adapted to access a wireless network and includes a subscriber identification module (SIM) card slot and a contactless smart card module electrically connected to the SIM card slot and thereby to the wireless mobile phone. The contactless smart card module is adapted to receive and read information stored in the contactless smart card and transmit this information to an entity through the wireless mobile device and the wireless network. The wireless mobile device of this invention is used to conduct financial transactions using the contactless smart card. The financial transactions include face-to-face or remote purchases, payment with electronic cash stored in the contactless smart card, or payment with the contactless smart card through a financial institution, and downloading and storing of digital goods or services in the contactless smart card.

### CROSS REFERENCE TO RELATED CO-PENDING APPLICATIONS

This application claims the benefit of U.S. provisional application Serial No. 60/399,686 filed on Jul. 30, 2002 and entitled MOBILE DEVICE EQUIPPED WITH A CONTACTLESS SMART CARD READER which is commonly assigned and the contents of which are expressly incorporated herein by reference.

### FIELD OF THE INVENTION

The present invention relates to mobile devices, and more particularly to a mobile device that is equipped with a contactless smart card reader/writer for conducting financial transactions with a contactless smart card.

### BACKGROUND OF THE INVENTION

The use of contactless smart cards, as defined in prior art U.S. Pat. No. 4,480,178, has experienced rapid growth particularly in the use of transit systems such as MiFare™ (developed by Phillips Semiconductors) and Octopus Cards (developed by Sony). These types of smart cards create a secure environment for storing monetary value while the contactless feature is fast and convenient for users who only need to bring the card in close proximity to a card reader. These types of contactless cards do not require a Personal Identification Number (PIN) and are therefore suited for high-volume, low-value transactions. Users of the card can load value onto the card by using an Automated Teller Machine (ATM) or a kiosk to transfer money from a checking account, savings account, a credit card account or by inserting cash into the ATM. The user puts their ATM card or cash into the machine and positions a contactless card near the contactless reader/writer to complete the transfer of money. These ATMs are typically located at the entrance to the transit station where the customers purchase transit tokens. The popularity of contactless cards for transit has grown so that other vendors in area surrounding the transit system also accept the contactless card for payment for purchases such as parking, fast food, convenience stores and vending machines. Many merchants are installing contactless smart card reader/writers in their stores to provide the ability to accept contactless smart cards as a form of payment. Because contactless smart card readers are required to load value onto a card and take value off of a card, the amount of readers in the marketplace is a key factor in determining the amount of usage of the contactless smart card.

The idea of adding a contactless reader/writer to a mobile phone is established in PCT WO 01/86599 A2, entitled “Smart Card Communications”. However, this prior art application specifies that the connection between the contactless reader/writer and the mobile phone is through “an interface connector such as those used for connecting to a regular data modem”. These type of interface connectors need to be customized for each type of mobile phone and the specific network that is connected to. Accordingly, there is a need for a universal connector that can be used in all types of mobile phones and all networks.

The general concept of a universal connector that can connect to any type of mobile phone and network is described in PCT patent application No. WO 99/66752, entitled “Communication Method and Apparatus Improvements”, the entire content of which is incorporated herein by reference. Referring to FIG. 2, this universal connector 200 connects to the mobile phone's existing Subscriber Identification module (SIM) slot 204 and utilizes a Central Processor Unit (CPU) 202 to coordinate the activities of multiple SIM cards 152, 156 and a full-size external smart card 153. This universal connector may be implemented as an attachment to a mobile phone or may be embedded in the mobile phone. Although this implementation includes several SIM cards and a card reader for regular contact type smart cards, it does not include a contactless smart card reader/writer. Accordingly, there is still a need for a universal contactless smart card reader/writer that can be attached to any phone and any network.

### SUMMARY OF THE INVENTION

In general, in one aspect the invention features a wireless mobile device adapted to access a wireless network. The wireless mobile device includes a subscriber identification module (SIM) card slot and a contactless smart card module electrically connected to the SIM card slot and thereby to the wireless mobile phone. The contactless smart card module is adapted to receive and read information stored in a contactless smart card and transmit this information to an entity via the wireless mobile device and the wireless network.

Implementations of this aspect of the invention may include one or more of the following features. The contactless smart card module is further adapted to receive information from the entity via the wireless network and transmit and write this information in the contactless smart card. The information may include cardholder identification information, card identification information, authentication information, smart card issuer information, financial institution information, digital goods, digital services, or digital currency. The digital goods include electronic cash, electronic coupons, electronic gift certificates, electronic transit tokens, music, software, movies, and books. The wireless mobile device may further include a memory; a SIM card connected to the SIM card slot and authenticating the wireless mobile device to the wireless network, a Central Processing Unit (CPU) and a first application program associated with the memory and the CPU and being adapted to receive and transmit instructions from the contactless smart card module to the wireless mobile phone and the reverse. The wireless mobile device may further include a second application program associated with the memory and the CPU and being adapted to route and transmit data and information among the wireless mobile phone, the smart card module, and other interfaces connected to the CPU. These other interfaces may be smart card interfaces, infrared transceiver interfaces, serial communication interfaces, or magnetic stripe reader interfaces. The first and second application programs may be stored in the CPU, the SIM card, an external SIM card, the contactless smart card, or an external card. The wireless mobile device may also include an antenna for receiving and transmitting messages to and from the contactless smart card. The wireless mobile device may be a mobile phone, a personal digital assistant, a pager, a wireless laptop computer, a personal computer, a television remote control, and combinations thereof. The wireless network may be a wireless wide area network (WWAN), a wireless local area network (WLAN), a private network, or a personal area network (PAN). The wireless wide area network (WWAN) may be a Global System for Mobile Communications (GSM), a Code Division Multiple Access (CDMA), CDMA 2000, or wideband CDMA (WCDMA). The wireless mobile device may be used for making financial transactions between a user and an entity with the contactless smart card over the network. The financial transactions between the user and the entity may be face-to-face or remote.

In general, in another aspect the invention features an electronic communication method including purchasing a good or a service from a merchant, and paying with a contactless smart card via a wireless mobile device. The wireless mobile device is adapted to access a wireless network and includes a subscriber identification module (SIM) card slot and a contactless smart card module electrically connected to the SIM card slot and thereby to the wireless mobile device. The contactless smart card module is adapted to receive and read information stored in the contactless smart card and transmit the information to an entity via wireless mobile device and the wireless network.

Implementations of this aspect of the invention may include one or more of the following features. The electronic communication method may further include receiving the good or service electronically, storing it in the contactless card, retrieving the good or service from the contactless card and redeeming it.

In general, in another aspect the invention features an electronic payment method utilized by a customer to pay a merchant with electronic cash stored in a contactless smart card for a face-to-face purchase of a good or service. The method includes placing an order by the customer for the purchase of the good or service to the merchant and providing a wireless mobile device wherein the mobile device is adapted to access a wireless network and comprises a subscriber identification module (SIM) card slot and a contactless smart card module electrically connected to the SIM card slot and wherein the contactless smart card module is adapted to receive and read information stored in the contactless smart card and transmit the information via the wireless network. Next, entering information of the purchase in the wireless mobile phone, positioning the contactless smart card in close proximity to the wireless mobile device and retrieving smart card identification information and authorizing withdrawal of an electronic cash amount for payment for the good or service from the smart card. Next, sending the purchase information, the smart card identification information and the electronic cash amount to an authentication server via the wireless network, and authenticating and sending the purchase information and the electronic cash amount by the authentication server to a business account of the merchant held in a financial institution. Next, registering the purchase information and depositing the electronic cash amount to the merchant's business account and sending confirmation by the financial institution to the authentication server. Finally, forwarding the confirmation to the wireless mobile phone and fulfilling the order to the customer by the merchant.

In general, in yet another aspect the invention features an electronic payment method utilized by a customer to pay a merchant with a contactless smart card for a face-to-face purchase of a good or service. The method includes placing an order by the customer for the purchase of the good or service to the merchant and providing a wireless mobile device wherein the wireless mobile device is adapted to access a wireless network and comprises a subscriber identification module (SIM) card slot and a contactless smart card module electrically connected to the SIM card slot and wherein the contactless smart card module is adapted to receive and read information stored in the contactless smart card and transmit the information via the wireless network. Next, entering information of the purchase in the wireless mobile phone, positioning the contactless smart card in close proximity to the wireless mobile device, and retrieving smart card identification information from the contactless smart card and authorizing payment for the good or service. Next, formatting the purchase information, the smart card identification information and the payment authorization into a first message and sending the first message to an authentication server via the wireless network, and authenticating and sending the first message by the authentication server to a financial institution. Next, registering the purchase information and sending approval for the payment by the financial institution to the authentication server. Finally, forwarding the payment approval to the wireless mobile phone and fulfilling the order to the customer by the merchant.

In general, in yet another aspect the invention features an electronic payment method utilized by a customer to pay a merchant with a contactless smart card for a remote purchase of a good or service. The method includes placing an order by the customer for the purchase of the good or service to a merchant server via a first network and choosing to pay via a wireless mobile device wherein the wireless mobile device is adapted to access a wireless network and comprises a subscriber identification module (SIM) card slot and a contactless smart card module electrically connected to the SIM card slot and wherein the contactless smart card module is adapted to receive and read information stored in the contactless smart card and transmit the information via the wireless network. Next, providing the merchant server with an identification information for the wireless mobile device and creating a digital order comprising purchase information and the identification number for the wireless mobile device by the merchant server. Next, routing the digital order to an authentication server via the first network, formatting the digital order into a first message wherein the first message is adapted to be transmitted over the wireless network and routing the first message over the wireless network to the wireless mobile device. Next, displaying the first message on the wireless mobile device, and requesting and receiving authorization of payment from the customer via the wireless mobile device. Next, positioning the contactless smart card in close proximity to the wireless mobile device, retrieving smart card identification and security information, and formatting authorization result and smart card identification and security information into a second message and routing the second message to the authentication server. Next, authenticating and routing the second message to a financial institution, wherein the financial institution is the issuer of the contactless smart card. Finally, approving and executing the payment at the financial institution, forwarding the payment approval to the authentication server and from the authentication server to the wireless mobile phone and fulfilling the order to the customer by the merchant.

Implementations of this aspect of the invention may include one or more of the following features. The good or service may be a digital good or a digital service and the fulfilling includes downloading and storing the digital good or service in the contactless smart card. The digital good may be electronic cash, electronic coupons, electronic gift certificates, electronic transit tokens, music, software, movies, or books. The wireless mobile device may be a mobile phone, a personal digital assistant, a pager, a wireless laptop computer, a personal computer, a television remote control, or combinations thereof. The wireless network may be a wireless wide area network (WWAN), a wireless local area network (WLAN), a private network, or a personal area network (PAN). The wireless wide area network (WWAN) may be a Global System for Mobile Communications (GSM), a Code Division Multiple Access (CDMA), CDMA 2000, or wideband CDMA (WCDMA). The first and second messages may be formatted in Short Message Service (SMS), General Packet Radio Service (GPRS), Transmission Control Protocol/Internet Protocol (TCP/IP), User Datagram Protocol (UDP), Simple Mail Transmission Protocol (SMTP), Simple Network Management Protocol (SNMP), or proprietary message formats.

Among the advantages of this invention may be one or more of the following. Combining a contactless smart card reader with a wireless mobile device can dramatically increase the number of smart card reader points of sales (POS) in the marketplace. The increased number of POS offers convenience to consumers and more opportunities to merchants. Consumers with wireless mobile devices equipped with a smart card reader can load value to their contactless cards anytime and anywhere and may use their contactless smart cards for mobile commerce purchases with the mobile device such as ring tones, mobile airtime credits and other types of remote purchases. Merchants that do not have the ability to install a traditional contactless smart card reader/writer that requires power from an electrical outlet and integration with a cash register would also benefit from a mobile contactless reader/writer for many types of transactions. These merchants include taxi cabs, vending machines and “push cart” vendors. Additionally, a wireless mobile device equipped with a contactless smart card reader enables “peer-to-peer” transfer of money using contactless cards.

The invention defined in this application specifies that the contactless smart card module connects to the wireless mobile device through the Subscriber Identification Module (SIM) circuitry on a GSM mobile phone. This configuration allows the contactless smart card module to function as any other type of smart card module as specified in the GSM 11.14 communication standards and enables any GSM phone that supports GSM 11.14 to utilize the contactless smart card module. The advantage to this standards-based design enables any application to access the contactless smart card module using GSM 11.14 commands (i.e. Power On Card, Read Card) without having to make modifications to the mobile device itself. Although a mobile device may have many external interface points (i.e. serial, USB, Bluetooth, Infrared), these communication protocols, while standard, are implemented differently for each mobile device, therefore connecting a contactless smart card reader to any other interface point on the mobile device would require a specific interface application developed for each mobile device. Most mobile devices do not allow applications to be installed or modified on the device once the device has been distributed to customers. The advantage of the present invention is that the contactless smart card module can be used to retrofit any mobile device that does not allow reprogramming with or without the permission or knowledge of the mobile device manufacturer or the mobile network operator.

Another advantage of the present invention is the creation of many types of systems and methods for using contactless smart cards for purchasing and fulfillment of goods and services because of the network connectivity established by the connected mobile device. As was mentioned above, the present invention provides a POS system for mobile merchants (i.e. taxi cab drivers and fast food vendors) and allows them to accept contactless smart cards as a form of payment. The present invention also enables consumers to make remote purchases using contactless smart cards as a method of payment. Finally, the present invention provides consumers with the ability to purchase and download digital goods such as coupons, transit coupons and electronic cash (e-Cash) to a contactless smart card.

### BRIEF DESCRIPTION OF THE DRAWINGS

FIG. 1 illustrates a circuitry according to this invention for a contactless smart card reader/writer module that converts a Single-SIM GSM phone into a Dual-SIM/Dual-Slot GSM phone with a contactless smart card reader/writer;

FIG. 2 illustrates a prior art circuitry for a mobile device attachment that converts a Single-SIM GSM phone into a Dual-SIM/Dual-Slot GSM phone with an external card reader;

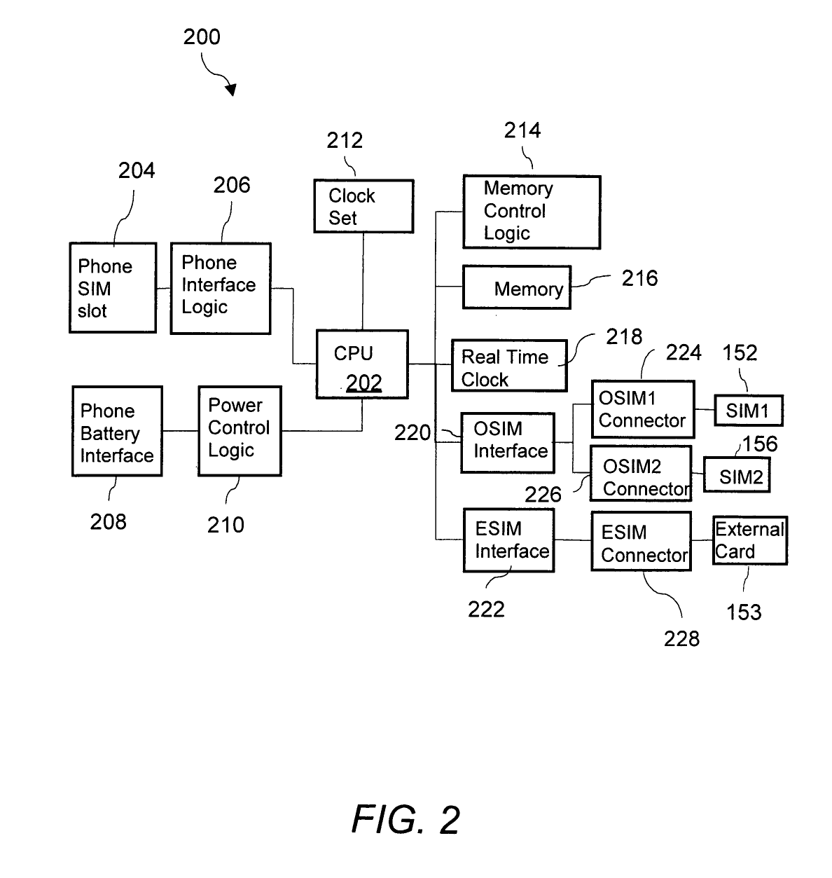

FIG. 3 illustrates a mobile phone with the contactless smart card reader/writer module of FIG. 1 and a contactless smart card;

FIG. 4 is a schematic diagram of a payment system utilizing the mobile phone of FIG. 3 for a face-to-face purchase according to this invention;

FIG. 5 is a schematic diagram of a payment system utilizing the mobile phone of FIG. 3 for remote purchases according to this invention;

FIG. 6 is a flow diagram of the remote payment system of FIG. 4;

FIG. 7 is a schematic diagram of a payment system for digital goods purchase and fulfillment using the mobile device of FIG. 3; and

FIG. 8 is a flow diagram of the payment and digital goods fulfillment system of FIG. 7.

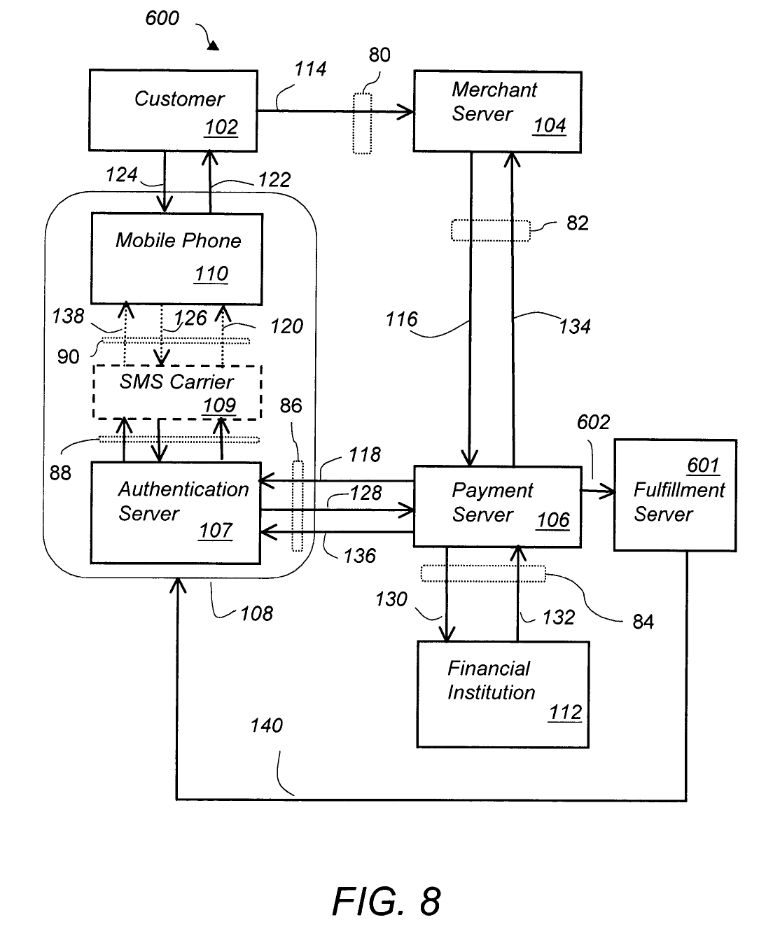

### DETAILED DESCRIPTION OF THE INVENTION

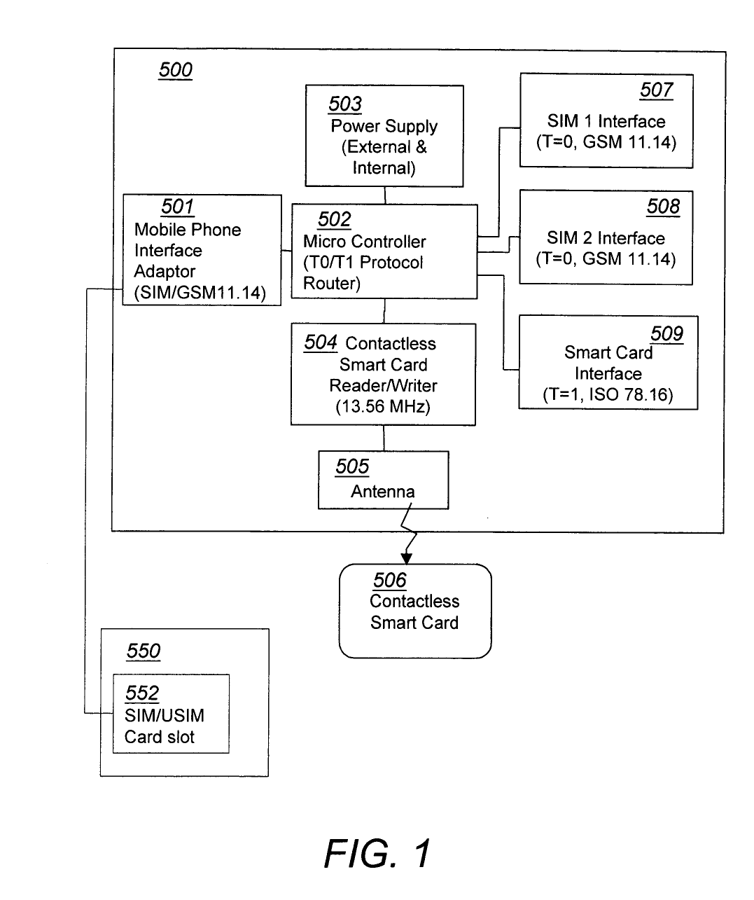

Referring to FIG. 1, a contactless smart card reader/writer module 500 is connected to a wireless mobile phone 550 through a Subscriber Identification Module/Universal Subscriber Identification Module (SIM/USIM) card slot 552. The contactless smart card reader/writer module 500 includes a mobile phone interface adaptor (501) that connects to the Subscriber Identification Module/Universal Subscriber Identification Module (SIM/USIM) card slot circuitry 552 of the wireless mobile phone 550. In one example, the mobile phone interface adaptor 501 is described in WO 99/66752 application and U.S. Pat. No. 6,292,561. The entire content of WO 99/66752 application and U.S. Pat. No. 6,292,561 is incorporated herein by reference. The contactless smart card reader/writer module 500 further includes a Micro Controller or Central Processing Unit (CPU) 502 that controls the mobile phone interface adaptor 501 and manages the routing of communications and controls between the mobile phone 550 and the contactless smart card reader/writer 504 as well as a plurality of smart cards. In addition to the contactless smart card reader/writer 504, module 500 includes a memory (not shown), SIM card interfaces 507, 508, adapted to receive SIM cards, and a smart card interface 509 that accepts regular contact-type smart cards. The CPU 502 receives commands from the mobile phone 550, analyzes the commands and routes those commands to the appropriate interface. The contactless smart card reader/writer 504 is connected to an antenna 505 that is mounted externally to the module or is embedded into the module's Printed Circuit Board (PCB). In other embodiments the antenna 505 is connected directly to the mobile phone 550. The contactless smart card reader/writer 504 receives activation commands and instructions via the CPU 502 from an application on any of the interfaces connected to the CPU 502, including an application on the mobile device interface 501, an application on the mobile phone 550, an application on the SIM Interface 507, an application on the SIM Interface 508, an application on the smart card Interface 509 or an application on the CPU itself. Using the antenna 505, module 500 receives and transmits information to and from a contactless smart card 506 using standard communication protocols as specified by ISO 14443 A/B and ISO 15693 standards using 13.56 MHz and 125 kHz frequencies. Module 500 is powered by a power supply 503 which may be either internal to the module or external.

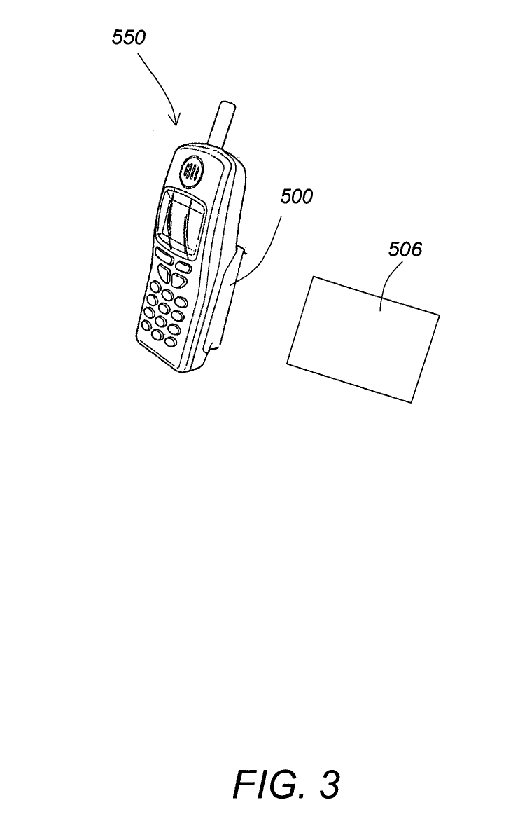

Referring to FIG. 3, for existing mobile phones, the module 500 is an attachment that connects to the existing SIM slot on the mobile phone 550. The module 500 may also be embedded within the mobile device. In either case, the mobile phone 550 receives and transmits information to and from a contactless smart card 506 when the contactless card 506 is brought in close proximity to the mobile phone 550.

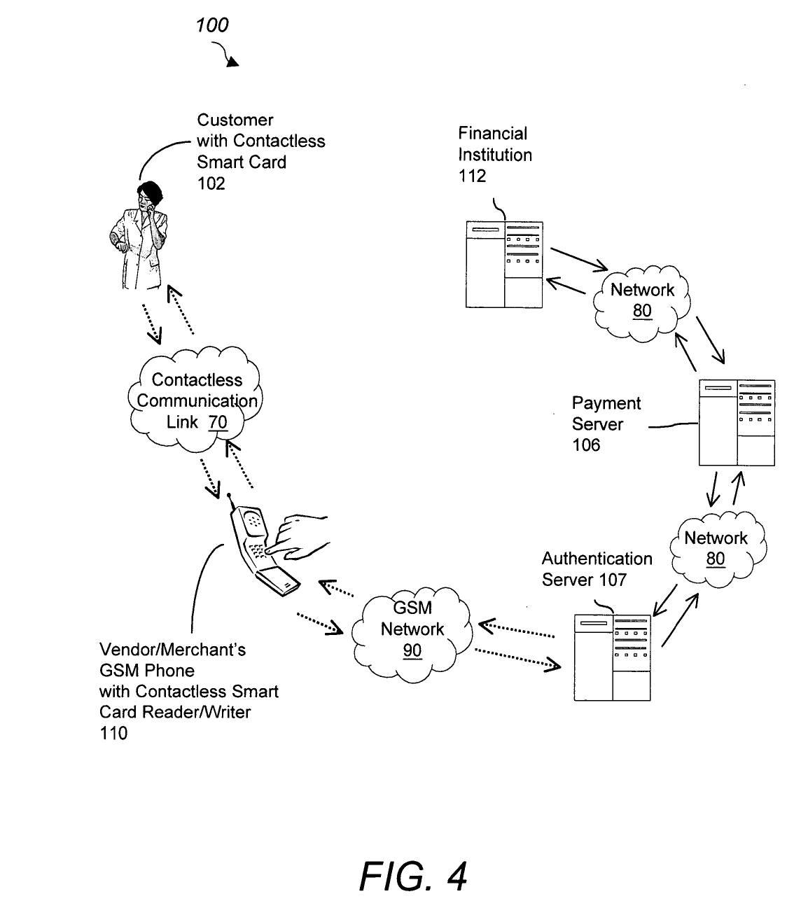

One embodiment of the present invention provides a contactless smart card payment system where the user of the mobile phone equipped with a contactless smart card reader is able to accept contactless smart cards as a form of payment for face-to-face purchases. Referring to FIG. 4, a payment transaction system 100 for a face-to-face purchase of a product or a service includes a customer 102 with a contactless smart card, a merchant with a mobile device 110 equipped with a contactless smart card reader, a payment server 106, an authentication server 107, and a financial institution 112. The authentication server 107 receives and transmits messages in a short message service (SMS) format to the merchant's mobile phone 110 via an SMS carrier through a wireless Global System for Mobile Communication (GSM) network 90. The mobile phone 110 receives and transmits information from and to a contactless smart card. After completing the purchase of a product or a service with the merchant, the customer 102 provides the merchant with the contactless smart card to pay for the purchase. The merchant activates a mobile payment application on the mobile device 110 and positions the contactless smart card in close proximity to the mobile device. The contactless smart card reader activates the application on the contactless smart card using wireless smart cards communication protocol 70. Using the contactless reader on the mobile phone 110, the payment application on the mobile device sends the appropriate commands to the smart card to deduct from the smart card the amount for the purchase. The mobile phone 110 encrypts the transaction information and sends a message to the authentication server 107 over the wireless GSM network 90. The message includes the merchant vendor information, type of purchase and the amount due. The authentication server 107 validates the transaction information from the mobile device, decrypts the transaction information and routes the transaction information to the payment server 106 over communication network 80. The payment server 106 connects to the merchant's financial institution 112 over communication network 80. The financial institution 112 processes the payment, updates the merchant's account and sends a confirmation of the payment to the payment server 106. The payment server 106 routes the payment confirmation to the authentication server 107. The authentication server 107 encrypts and sends a message confirming the payment to the merchant's mobile device 110. In one example, the authentication server 107 is described in a co-pending patent application entitled “System and method for payment transaction authentication”, the entire content of which is incorporated herein by reference.

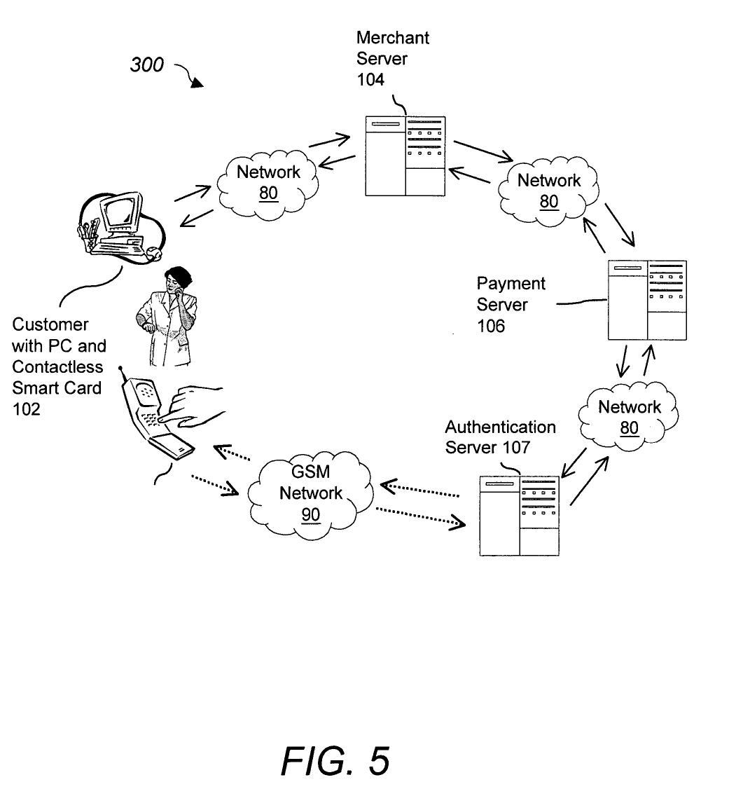

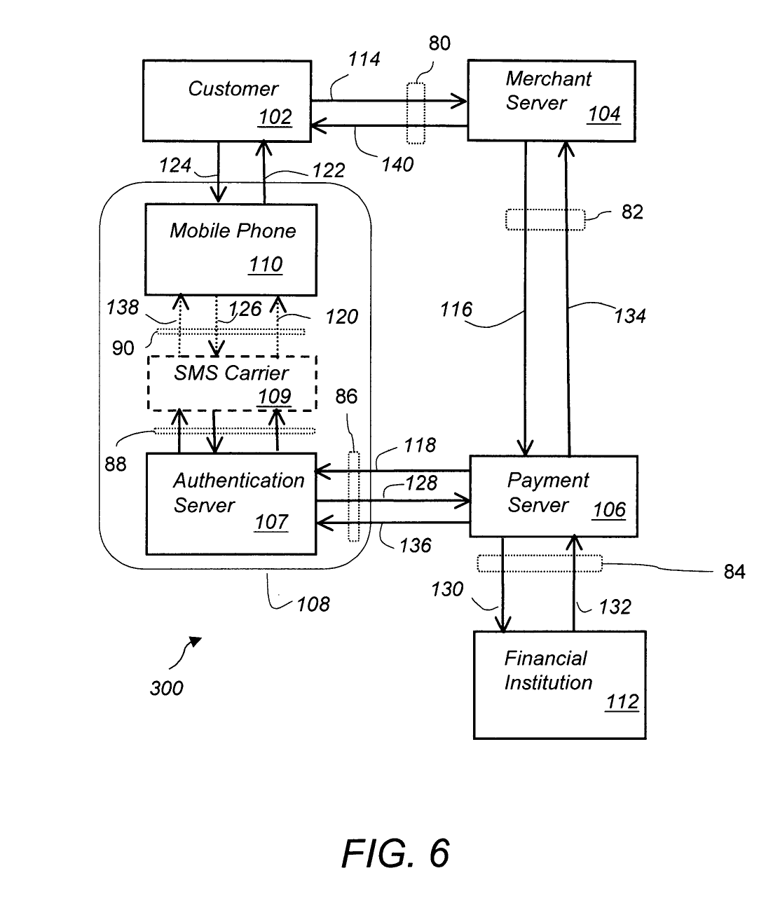

In another embodiment, the present invention provides a contactless smart card payment system for consumers making remote purchasing and payment transactions. Referring to FIG. 5 and FIG. 6, a payment transaction system 300 includes a customer 102, a merchant server 104, a payment server 106, an authentication system 108, and a financial institution 112. The authentication system 108 includes an authentication server 107 that is adapted to send and receive messages in a short message service (SMS) format to a mobile phone 110 via an SMS carrier 109. The mobile phone 110 is adapted to receive a contactless smart card (not shown). After having placed an order for an item or a service through a personal computer (PC) connected via the Internet 80 to the merchant server 104, a customer 102 is asked to choose a payment method. The customer 102 chooses to pay via her mobile phone 110 and gives her mobile phone identification information to the merchant server 104 (114). In one example, the mobile phone identification information is the mobile phone number. The merchant server 104 routes the customer's mobile phone number and information about the purchase order to a payment server 106 (116). The payment server 106 contacts the authentication server 107 and routes the customer's mobile phone number and information about the purchase (118). The authentication server 107 sends an SMS message to the customer's mobile phone 110 through an SMS carrier 109 (120). The customer 102 receives the SMS message asking her to authorize the purchase and choose a payment card (122). The customer 102 authorizes the purchase, positions the contactless smart card in proximity to her mobile phone 110, and enters a security code (if required) to pay and authenticate her purchase (124). In one example, the security code is a personal identification number (PIN). Other examples include a password, digital signature, and a biometric identifier, i.e., retina scan, fingerprint, DNA scan, voice characteristics. The payment card is identified with information that is embedded in the card. In one example the identification information is a payment card number. Other examples of payment card identification include an encrypted transaction signature that can only be decrypted by the financial institution that has issued the payment card, expiration date of the payment card, and a digital signature. In another example the payment card may contain an electronic purse (e-Purse) with stored value (i.e. e-Cash, e-Coupon, e-Ticket) contained within the smart card and the amount of the transaction is deducted from the e-Purse. The mobile phone 110 sends an SMS message via the SMS Carrier 109 to the authentication server 107. The SMS message includes the authorization result (if required) and payment transaction information. The authentication server 107 routes the authorized purchase order and authenticated card information to the payment server 106 (128). If the transaction is not a stored value smart card transaction, the payment server 106 contacts the financial institution 112 that has issued the payment card and routes the payment card information and the purchase order information (130). If the transaction is a stored value transaction, the payment server 106 contacts the financial institution of the merchant and routes the payment transaction information. The financial institution 112 processes the payment transaction and sends a confirmation of the payment transaction to the payment server 106 (132). The payment server 106 routes the payment confirmation to the merchant server 104 (134) and to authentication server 107 (136). The authentication server 107 sends an SMS message confirming the payment transaction to the customer's mobile phone 110 (138). Finally the merchant 104 fulfills the customer's purchase order (140).

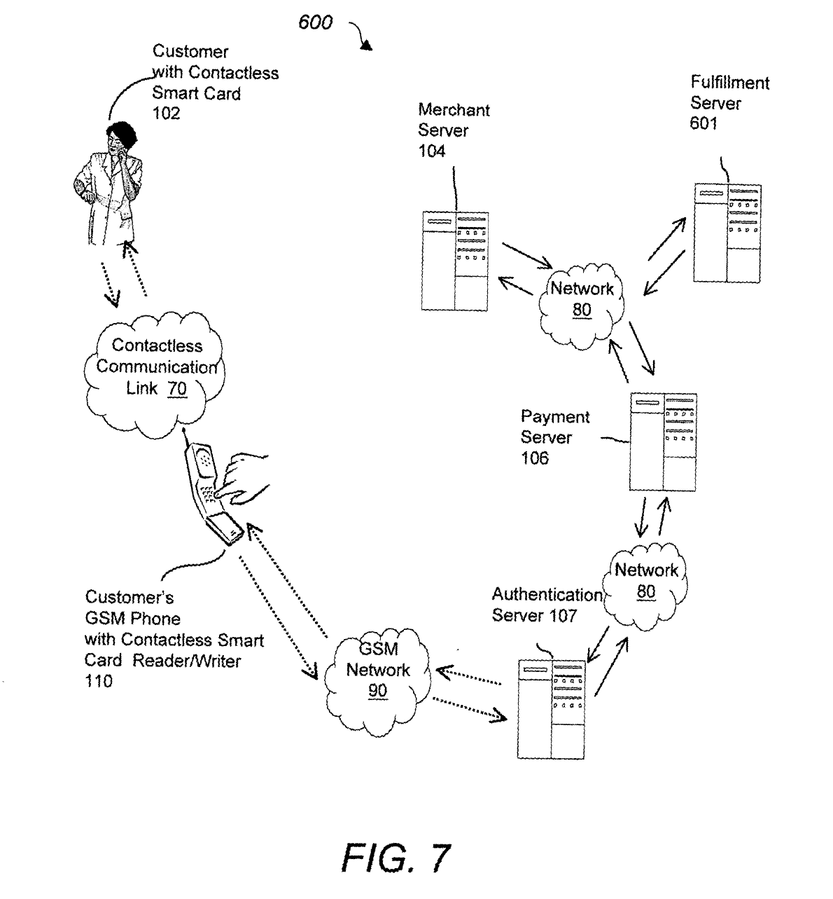

In another embodiment, the present invention provides a contactless smart card payment and digital goods fulfillment system. The contactless smart card has the ability to retain stored value or other types of information within the card. These “digital goods” are electronic, virtual information that represent value such as electronic cash (e-Cash), electronic coupons (e-Coupon), electronic tickets (e-Ticket), electronic transit tokens and digital media such as music, software, movies, books and other digital content. The payment transaction and digital goods fulfillment system allows the purchase of digital goods and reception and storage of the digital goods on the contactless smart card. Referring to FIG. 7 and FIG. 6, a payment transaction and digital goods fulfillment system 600 includes a customer 102 with a contactless smart card and a mobile device 110 equipped with contactless smart card reader/writer 110, a merchant server 104, a payment server 106, an authentication system 108, a financial institution 112 and a fulfillment server 601. The authentication system 108 includes an authentication server 107 that is adapted to send and receive messages in a short message service (SMS) format to a mobile phone 110 via an SMS carrier 109. The mobile phone 110 is adapted to receive the contactless smart payment card. After having placed an order for digital goods via the Internet, SMS, WAP or voice 80, a customer 102 is asked to choose a payment method. The customer 102 chooses to pay via her mobile phone 110 and gives her mobile phone identification information to the merchant server 104 (114). In one example, the mobile phone identification information is the mobile phone number. The merchant server 104 routes the customer's mobile phone number and information about the purchase order to a payment server 106 (116). The payment server 106 contacts the authentication server 107 and routes the customer's mobile phone number and information about the purchase (118). The authentication server 107 sends an SMS message to the customer's mobile phone 110 through an SMS carrier 109 (120). The customer 102 receives the SMS message asking her to authorize the purchase and choose a payment card (122). The customer 102 authorizes the purchase, uses a smart card that is associated with her mobile phone 110, and enters a security code to pay and authenticate her purchase (124). In one example, the security code is a personal identification number (PIN). Other examples include a password, digital signature, and a biometric identifier, i.e., retina scan, fingerprint, DNA scan, voice characteristics. The payment card is identified with information that is embedded in the card. In one example the identification information is a payment card number. Other examples of payment card identification include an encrypted transaction signature that can only be decrypted by the financial institution that has issued the payment card, expiration date of the payment card, and a digital signature. The mobile phone 110 sends an SMS message via the SMS Carrier 109 to the authentication server 107. The SMS message includes the authorization result and payment transaction information (126). The authentication server 107 routes the authorized purchase order and authenticated card to the payment server 106 (128). The payment server 106 contacts the financial institution 112 that has issued the payment card and routes the payment card information and the purchase order information (130). The financial institution 112 processes the payment transaction and sends a confirmation of the payment transaction to the payment server 106 (132). The payment server 106 routes the payment confirmation to the merchant server 104 (134), presents a digital receipt to the fulfillment server 601 (602) and routes the payment confirmation to the authentication server 107 (136). The authentication server 107 sends an SMS message confirming the payment transaction to the customer's mobile phone 110 (138). Finally the fulfillment server 601 fulfills the customer's order for digital goods (140) by sending the electronic information that represents the digital goods to the authentication server 107. The authentication server 107 sends an SMS message to the customer's mobile phone 110 through an SMS carrier 109 (120). The mobile phone 110 receives the digital goods from the authentication server 107 and the customer 102 receives a message that digital goods are available for the contactless smart card. The customer 102 positions the contactless smart card in close proximity to the mobile phone 110 that is equipped with a contactless smart card reader/writer. The mobile phone 110 establishes a communication link 70 with the contactless smart card and transfers the digital goods to the contactless smart card.

Other embodiments are within the scope of the following claims. For example, the mobile phone identification information may be an Internet Protocol (IP) address. The communication networks 80, 82, 84, 86, 88 and 90 may be wireless or wired networks. The communication networks 80, 82, 84, 86, 88 and 90 may be non face-to-face via the Internet, VPN (Virtual Private Network), cable network, data network, telephone network, private voice and data networks, public voice and data networks, and mail or person to person. Payment card identification may occur via the payment card number or via an encrypted transaction signature that can only be decrypted by the financial institution that has issued the payment card. The authentication server may also utilize a password, digital signature, or a biometric identifier, i.e., retina scan, fingerprint, voice characteristics, to authenticate the payment transaction. The payment authentication instrument may be contained in the contactless smart card, on the SIM smart cards within the mobile phone 110, or within another full-size smart card that needs to be inserted into a smart card reader slot. The communication between the authentication server 107 and the mobile phone 110 may be via a proprietary message protocol that utilizes User Datagram Protocol (UDP) on top of Internet Protocol (IP). This proprietary message protocol is adapted to be used with wireless networks that support Transmission Control Protocol/Internet Protocol (TCP/IP). These wireless networks include Bluetooth, 3G, GPRS, 2.5G, Infrared, 802.11a and 802.11b.

Several embodiments of the present invention have been described. Nevertheless, it will be understood that various modifications may be made without departing from the spirit and scope of the invention. Accordingly, other embodiments are within the scope of the following claims.

What is claimed is:

1. A wireless mobile device adapted to access a wireless network comprising:
a subscriber identification module (SIM) card slot; and
a contactless smart card module electrically connected to said SIM card slot; and
wherein said contactless smart card module is adapted to receive and read information stored in a contactless smart card and transmit said information to an entity via said wireless network.

2. The wireless mobile device of claim 1 wherein said contactless smart card module is further adapted to receive information from said entity via said network and transmit and write said information in said contactless smart card.

3. The wireless mobile device of claim 1 wherein said information is selected from a group consisting of cardholder identification information, card identification information, authentication information, smart card issuer information, financial institution information, digital goods, digital services, and digital currency.

4. The wireless mobile device of claim 3 wherein said digital goods are selected from a group consisting of electronic cash, electronic coupons, electronic gift certificates, electronic transit tokens, music, software, movies, and books.

5. The wireless mobile device of claim 1 further comprising;
a memory;
a Central Processing Unit (CPU);
a SIM card connected to said SIM card slot, said SIM card authenticating said wireless mobile device to said wireless network; and
a first application program associated with said memory and said CPU and being adapted to receive and transmit instructions from said contactless smart card module to said wireless mobile phone and the reverse.

6. The wireless mobile device of claim 5 further comprising a second application program associated with said memory and said CPU and being adapted to route and transmit data and information among said wireless mobile phone, said smart card module, and other interfaces connected to said CPU.

7. The wireless mobile device of claim 6 wherein said other interfaces are selected from a group consisting of smart card interfaces, infrared transceiver interfaces, serial communication interfaces, and magnetic stripe reader interfaces.

8. The wireless mobile device of claim 6 wherein said first and second application programs are stored in storage selected from a group consisting of said CPU, said SIM card, an external SIM card, said contactless smart card, and an external card.

9. The wireless mobile device of claim 1 further comprising an antenna for receiving and transmitting messages to and from said contactless smart card.

10. The wireless mobile device of claim 1 wherein said wireless mobile device is selected from a group consisting of a mobile phone, a personal digital assistant, a pager, a wireless laptop computer, a personal computer, a television remote control, and combinations thereof.

11. The wireless mobile device of claim 1 wherein said wireless network is selected from a group consisting of a wireless wide area network (WWAN), a wireless local area network (WLAN), a private network, and a personal area network (PAN).

12. The wireless mobile device of claim 11 wherein said wireless wide area network (WWAN) is selected from a group consisting of a Global System for Mobile Communications (GSM), a Code Division Multiple Access (CDMA), CDMA 2000, and wideband CDMA (WCDMA).

13. The wireless mobile device of claim 1 wherein said wireless mobile device is used for making financial transactions between a user and said entity with said contactless smart card over said network.

14. The wireless mobile device of claim 13 wherein said financial transactions between said user and said entity are face-to-face.

15. The wireless mobile device of claim 13 wherein said financial transactions between said user and said entity are remote.

16. An electronic communication method comprising:
purchasing a good or a service from a merchant; and
paying with a contactless smart card via a wireless mobile device;
wherein said wireless mobile device is adapted to access a wireless network and comprises a subscriber identification module (SIM) card slot and a contactless smart card module electrically connected to said SIM card slot and wherein said contactless smart card module is adapted to receive and read information stored in said contactless smart card and transmit said information to an entity via said wireless network.

17. The electronic communication method of claim 16 further comprising receiving said good or service electronically and storing it in said contactless card.

18. The electronic communication method of claim 14 further comprising retrieving said good or service from said contactless card and redeeming it.

19. An electronic payment method utilized by a customer to pay a merchant with electronic cash stored in a contactless smart card for a face-to-face purchase of a good or service comprising:
placing an order by said customer for said purchase of said good or service to said merchant;
providing a wireless mobile device wherein said mobile device is adapted to access a wireless network and comprises a subscriber identification module (SIM) card slot and a contactless smart card module electrically connected to said SIM card slot and wherein said contactless smart card module is adapted to receive and read information stored in said contactless smart card and transmit said information via said wireless network;
entering information of said purchase in said wireless mobile phone;
positioning said contactless smart card in close proximity to said wireless mobile device, retrieving smart card identification information and authorizing withdrawal of an electronic cash amount for payment for said good or service from said smart card;
sending said purchase information, said smart card identification information and said electronic cash amount to an authentication server via said wireless network;
authenticating and sending said purchase information and said electronic cash amount by said authentication server to a business account of said merchant held in a financial institution;
registering said purchase information and depositing said electronic cash amount to said merchant's business account and sending confirmation by said financial institution to said authentication server;
forwarding said confirmation to said wireless mobile phone; and
fulfilling said order to said customer by said merchant.

20. An electronic payment method utilized by a customer to pay a merchant with a contactless smart card for a face-to-face purchase of a good or service comprising:
placing an order by said customer for said purchase of said good or service to said merchant;
providing a wireless mobile device wherein said wireless mobile device is adapted to access a wireless network and comprises a subscriber identification module (SIM) card slot and a contactless smart card module electrically connected to said SIM card slot and wherein said contactless smart card module is adapted to receive and read information stored in said contactless smart card and transmit said information via said wireless network;
entering information of said purchase in said wireless mobile phone;
positioning said contactless smart card in close proximity to said wireless mobile device, retrieving smart card identification information from said contactless smart card and authorizing payment for said good or service;
formatting said purchase information, said smart card identification information and said payment authorization into a first message and sending said first message to an authentication server via said wireless network;
authenticating and sending said first message by said authentication server to a financial institution;
registering said purchase information and sending approval for said payment by said financial institution to said authentication server;
forwarding said payment approval to said wireless mobile phone; and
fulfilling said order to said customer by said merchant.

21. The electronic payment method of claim 20 wherein said first message comprises a format selected from a group consisting of Short Message Service (SMS), General Packet Radio Service (GPRS), Transmission Control Protocol/Internet Protocol (TCP/IP), User Datagram Protocol (UDP), Simple Mail Transmission Protocol (SMTP), Simple Network Management Protocol (SNMP), and proprietary message formats.

22. An electronic payment method utilized by a customer to pay a merchant with a contactless smart card for a remote purchase of a good or service comprising:
placing an order by said customer for said purchase of said good or service to a merchant server via a first network and choosing to pay via a wireless mobile device wherein said wireless mobile device is adapted to access a wireless network and comprises a subscriber identification module (SIM) card slot and a contactless smart card module electrically connected to said SIM card slot and wherein said contactless smart card module is adapted to receive and read information stored in said contactless smart card and transmit said information via said wireless network;
providing said merchant server with an identification information for said wireless mobile device;
creating a digital order comprising purchase information and said identification number for said wireless mobile device by said merchant server;
routing said digital order to an authentication server via said first network;
formatting said digital order into a first message wherein said first message is adapted to be transmitted over said wireless network;
routing said first message over said wireless network to said wireless mobile device;
displaying said first message on said wireless mobile device;
requesting and receiving authorization of payment from the customer via said wireless mobile device;
positioning said contactless smart card in close proximity to said wireless mobile device and retrieving smart card identification and security information;
formatting authorization result and smart card identification and security information into a second message and routing said second message to said authentication server;
authenticating and routing said second message to a financial institution, wherein said financial institution is the issuer of said contactless smart card; and
approving and executing said payment at said financial institution.
forwarding said payment approval to said authentication server and from said authentication server to said wireless mobile phone; and
fulfilling said order to said customer by said merchant.

23. The electronic payment method of claim 22 wherein said good or service comprises a digital good or a digital service and wherein said fulfilling comprises downloading and storing said digital good or service in said contactless smart card.

24. The electronic payment method of claim 23 wherein said digital good is selected from a group consisting of electronic cash, electronic coupons, electronic gift certificates, electronic transit tokens, music, software, movies, and books.

25. The electronic payment method of claim 22 wherein said wireless mobile device is selected from a group consisting of a mobile phone, a personal digital assistant, a pager, a wireless laptop computer, a personal computer, a television remote control, and combinations thereof.

26. The electronic payment method of claim 22 wherein said wireless network is selected from a group consisting of a wireless wide area network (WWAN), a wireless local area network (WLAN), a private network, and a personal area network (PAN).

27. The electronic payment method of claim 26 wherein said wireless wide area network (WWAN) is selected from a group consisting of a Global System for Mobile Communications (GSM), a Code Division Multiple Access (CDMA), CDMA 2000, and wideband CDMA (WCDMA).

28. The electronic payment method of claim 22 wherein said first and second messages comprise a format selected from a group consisting of Short Message Service (SMS), General Packet Radio Service (GPRS), Transmission Control Protocol/Internet Protocol (TCP/IP), User Datagram Protocol (UDP), Simple Mail Transmission Protocol (SMTP), Simple Network Management Protocol (SNMP), and proprietary message formats.
